(19) United States
(12) Patent Application Publication
(10) Pub. No.: US 2019/0081708 A1
(43) Pub. Date: Mar. 14, 2019

(54) Signal Generation Method and Device

(71) Applicant: Huawei Technologies Co., Ltd., Shenzhen (CN)

(72) Inventors: Shengmeng Fu, Wuhan (CN); Hongguang Zhang, Wuhan (CN); Jiangwei Man, Wuhan (CN); Jianhe Gao, Wuhan (CN)

(21) Appl. No.: 16/185,922

(22) Filed: Nov. 9, 2018

Related U.S. Application Data
(63) Continuation of application No. PCT/CN2016/102741, filed on Oct. 20, 2016.

(30) Foreign Application Priority Data
May 10, 2016 (CN) 201610304100.2

(51) Int. Cl. H04B 10/516; H04L 27/04; H04B 10/67

(52) U.S. Cl. CPC H04B 10/5161; H04B 10/677; H04L 27/04

(57) ABSTRACT

A method includes: sending, by a signal transmitting device, a first PAM signal to a signal receiving device, where the first PAM signal includes N first level amplitudes, and N≥3; receiving, by the transmitting device, feedback parameters sent by the receiving device, where the feedback parameters are determined based on the first PAM signal; determining, by the transmitting device, N target level amplitudes based on the feedback parameters, where intervals between every two adjacent target level amplitudes in the N target level amplitudes are different from each other; and generating, by the transmitting device based on the N target level amplitudes, a second PAM signal that needs to be sent to the receiving device.

### CROSS-REFERENCE TO RELATED APPLICATIONS

This application is a continuation of International Application No. PCT/CN2016/102741, filed on Oct. 20, 2016, which claims priority to Chinese Patent Application No. 201610304100.2, filed on May 10, 2016. The disclosures of the aforementioned applications are hereby incorporated by reference in their entireties.

### TECHNICAL FIELD

Embodiments of the present invention relate to the field of passive optical networks, and more specifically, to a signal generation method and device.

### BACKGROUND

To meet a requirement of an access network for a rapid rate increase, a higher-order PAM modulation format is used, so that a system transmission rate can be improved while system costs and complexity are not increased. For a high-speed passive optical network (PON) system, to increase a power budget of the system, a receive end receives a PAM signal by using an avalanche photodiode (APD).

Noise generated by the APD in a working process is related to a signal strength and a signal amplitude. When the signal amplitude is fixed, a greater signal strength (or power) leads to greater noise. For a conventional multi-amplitude PAM signal, a plurality of level amplitudes is distributed at equal intervals (hereafter referred as equal-interval distribution). Therefore, if a PAM signal with equal-interval distribution is received by using the APD, quality factor Q value between two adjacent high levels in an eye pattern consisting of the PAM signal is reduced and bit error rate (BER) of the system is increased.

In a current system, to resolve the foregoing problem, a component for generating a multi-amplitude PAM signal with unequal-interval distribution is proposed, and can generate a PAM signal with unequal-interval distribution, so that an interval between two adjacent level amplitudes increases as the level amplitude increases. In this way, when the APD component receives a PAM signal with unequal-interval distribution, a Q value between two adjacent high levels is not reduced as the level amplitude increases, and the bit error rate of the system can be reduced.

Although a PAM signal with unequal-interval distribution is generated in the current system, the PAM signal is obtained through rough estimation by human eyes with assistance of human adjustment. In other words, specific magnitude of level amplitudes of the PAM signal with unequal-interval distribution cannot be determined in the current system.

### SUMMARY

This application provides a signal generation method and device, so that specific magnitude of level amplitudes of a PAM signal with unequal-interval distribution can be determined during generation of the PAM signal.

According to a first aspect, this application provides a signal generation method. The method includes: sending, by a signal transmit end device, a first PAM signal to a signal receive end device, where the first PAM signal includes N first level amplitudes, and N≥3. The method also includes receiving, by the signal transmit end device, feedback parameters sent by the signal receive end device, where the feedback parameters are determined by the signal receive end device based on the first PAM signal. The method also includes determining, by the signal transmit end device, N target level amplitudes based on the feedback parameters, where intervals between every two adjacent target level amplitudes in the N target level amplitudes are different from each other. The method also includes generating, by the signal transmit end device based on the N target level amplitudes, a second PAM signal that needs to be sent to the signal receive end device.

With reference to the first aspect, in a first implementation of the first aspect, the determining, by the signal transmit end device, N target level amplitudes based on the feedback parameters includes: generating, by the signal transmit end device, N reference level amplitudes based on the feedback parameters and preset parameters; determining, by the signal transmit end device, a quality factor between every two adjacent reference level amplitudes in the N reference level amplitudes, to obtain (N−1) quality factors; and when a difference between any two quality factors in the (N−1) quality factors is less than or equal to a preset threshold, determining, by the signal transmit end device, the N reference level amplitudes as the N target level amplitudes.

With reference to the first aspect and the foregoing implementation, in a second implementation of the first aspect, before the receiving, by the signal transmit end device, feedback parameters sent by the signal receive end device, the method further includes: sending, by the signal transmit end device, a report request to the signal receive end device, where the report request is used to instruct the signal receive end device to report the feedback parameters.

With reference to the first aspect and the foregoing implementations, in a third implementation of the first aspect, the method is applied to a broadcast-type network, and the broadcast-type network includes at least two signal receive end devices, the sending, by a signal transmit end device, a first PAM signal to a signal receive end device includes: sending, by the signal transmit end device, the first PAM signal to the at least two signal receive end devices; the receiving, by the signal transmit end device, feedback parameters sent by the signal receive end device includes: receiving, by the signal transmit end device, at least two feedback parameters sent by the at least two signal receive end devices, where the at least two feedback parameters correspond one-to-one to the at least two signal receive end devices; and the determining, by the signal transmit end device, N target level amplitudes based on the feedback parameters includes: determining, by the signal transmit end device, the N target level amplitudes based on a minimum value of the at least two feedback parameters.

According to a second aspect, this application provides a signal generation method. The method includes receiving, by a signal receive end device, a first PAM signal sent by a signal transmit end device, where the first PAM signal includes N first level amplitudes, and N≥3. The method also includes determining, by the signal receive end device, feedback parameters based on the first PAM signal. The method also includes sending, by the signal receive end device, the feedback parameters to the signal transmit end device, so that the signal transmit end device determines N target level amplitudes based on the feedback parameters, and generates, based on the N target level amplitudes, a second PAM signal that needs to be sent to the signal receive end device, where intervals between every two adjacent target level amplitudes in the N target level amplitudes are different from each other.

With reference to the second aspect, in a first implementation of the second aspect, before the sending, by the signal receive end device, the feedback parameters to the signal transmit end device, the method further includes: receiving, by the signal receive end device, a report request sent by the signal transmit end device, where the report request is used to instruct the signal receive end device to report the feedback parameters; and the sending, by the signal receive end device, the feedback parameters to the signal transmit end device includes: sending, by the signal receive end device, the feedback parameters to the signal transmit end device based on the report request.

In some implementations, the feedback parameters are an average level power and an extinction ratio ER of N first levels, or the feedback parameters are a maximum level power and a minimum level power of N first levels, where the N first levels correspond one-to-one to the N first level amplitudes, and each first level amplitude is an amplitude value of a corresponding first level.

In some implementations, a value of N is 4, and when the feedback parameters are the average level power and the extinction ratio (ER), the preset parameters are any two of the four first levels and extinction ratios between every two adjacent levels in the four first levels; or when the feedback parameters are the maximum level power and the minimum level power, the preset parameters are any two of extinction ratios between every two adjacent levels in the four first levels.

According to a third aspect, this application provides a signal transmit end device, configured to perform the method in the first aspect or any possible implementation of the first aspect. Specifically, the signal transmit end device includes units for performing the method in the first aspect or any possible implementation of the first aspect.

According to a fourth aspect, this application provides a signal receive end device, configured to perform the method in the second aspect or any possible implementation of the second aspect. Specifically, the signal receive end device includes units for performing the method in the second aspect or any possible implementation of the second aspect.

According to a fifth aspect, this application provides a signal transmit end device. The device includes a receiver, a transmitter, a processor, a memory, and a bus system. The receiver, the transmitter, the processor, and the memory are connected by using the bus system. The memory is configured to store an instruction. The processor is configured to execute the instruction stored in the memory, to control the receiver to receive a signal and control the transmitter to send a signal. Further, when executing the instruction stored in the memory, the processor performs the method in the first aspect or any possible implementation of the first aspect.

According to a sixth aspect, this application provides a signal receive end device. The device includes a receiver, a transmitter, a processor, a memory, and a bus system. The receiver, the transmitter, the processor, and the memory are connected by using the bus system. The memory is configured to store an instruction. The processor is configured to execute the instruction stored in the memory, to control the receiver to receive a signal and control the transmitter to send a signal. Further, when executing the instruction stored in the memory, the processor performs the method in the second aspect or any possible implementation of the second aspect.

According to a seventh aspect, this application provides a computer readable medium, configured to store a computer program, where the computer program includes an instruction for performing the method in the first aspect or any possible implementation of the first aspect.

According to an eighth aspect, this application provides a computer readable medium, configured to store a computer program, where the computer program includes an instruction for performing the method in the second aspect or any possible implementation of the second aspect.

According to the signal generation method and device provided in this application, the signal receive end device feeds back information of the received PAM signal to the signal transmit end device, so that the signal transmit end device can determine specific magnitude of level amplitudes of a PAM signal with unequal-interval distribution during generation of the PAM signal.

### BRIEF DESCRIPTION OF THE DRAWINGS

To describe the technical solutions in the embodiments of the present invention more clearly, the following briefly describes the accompanying drawings required for describing the embodiments of the present invention. Apparently, the accompanying drawings in the following description show merely some embodiments of the present invention, and a person of ordinary skill in the art may still derive other drawings from these accompanying drawings without creative efforts.

FIG. 1 is a schematic interaction diagram of a signal generation method according to an embodiment of the present invention;

FIG. 2 is a schematic diagram of a multi-amplitude PAM signal according to an embodiment of the present invention;

FIG. 3 is a flowchart of determining target level amplitudes of a PAM4 signal with unequal-interval distribution;

FIG. 4 shows an APD-ROSA component model;

FIG. 5 is a schematic diagram of application of a signal generation method to a PON network according to an embodiment of the present invention;

FIG. 6 shows an example of a schematic interaction diagram of an OLT and an ONU;

FIG. 7 shows another example of a schematic interaction diagram of an OLT and an ONU;

FIG. 8 is a schematic block diagram of a signal transmit end device 500 according to an embodiment of the present invention;

FIG. 9 is a schematic block diagram of a signal receive end device 600 according to an embodiment of the present invention;

FIG. 10 is a schematic structural diagram of a signal transmit end device 700 according to an embodiment of the present invention; and

FIG. 11 is a schematic structural diagram of a signal receive end device 800 according to an embodiment of the present invention.

### DETAILED DESCRIPTION OF ILLUSTRATIVE EMBODIMENTS

The following describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

A signal generation method in the embodiments of the present invention is applicable to various multi-amplitude PAM signals, such as PAM4, PAM8, and PAM16. For ease of understanding and description, the signal generation method according to the embodiments of the present invention is described only by using PAM4 as an example in the embodiments of the present invention.

It should be understood that, in the embodiments of the present invention, serial numbers “first” and “second” are merely used to distinguish different objects, for example, to distinguish different PAM signals or different level amplitudes, and shall not constitute any limitation on the protection scope of the embodiments of the present invention.

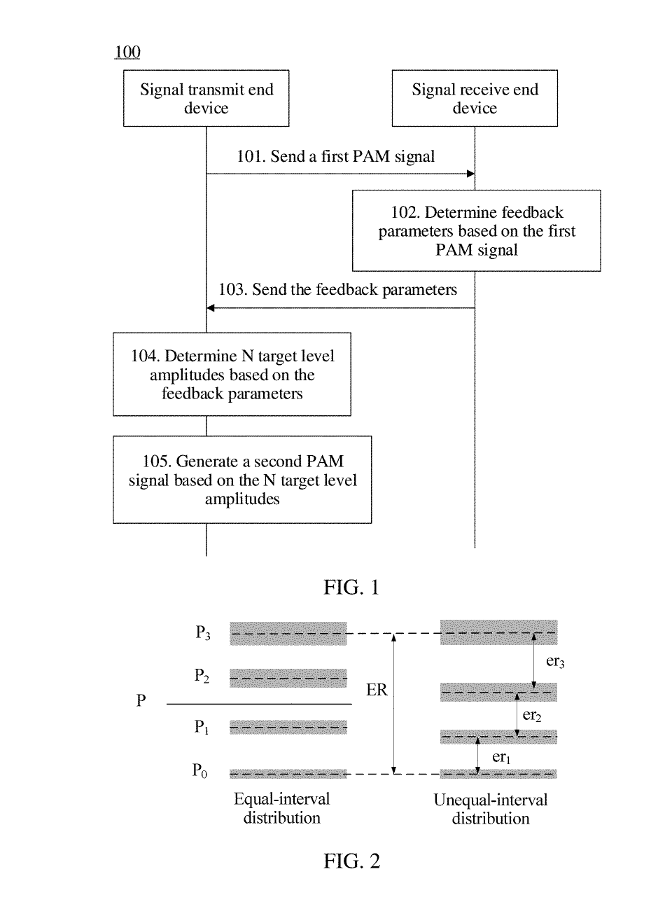

FIG. 1 is a schematic interaction diagram of a signal generation method 100 according to an embodiment of the present invention. As shown in FIG. 1, the method 100 includes the following steps.

101. A signal transmit end device sends a first PAM signal to a signal receive end device.

Specifically, the first PAM signal includes N first level amplitudes, and N≥3. For example, when N=4, the first PAM signal is a PAM4 signal. For another example, when N=8, the first PAM signal is a PAM8 signal.

It may be understood that, when N=2, a PAM signal includes two level amplitudes, and does not involve an issue of distributing the level amplitudes at unequal intervals. Therefore, in the method for generating a multi-amplitude PAM signal with unequal-interval distribution according to this embodiment of the present invention, a minimum value of N is 3.

In this embodiment of the present invention, the N first level amplitudes included by the first PAM signal may be distributed at equal intervals, or distributed at unequal intervals.

It should be noted that the first PAM signal sent by the signal transmit end device to the signal receive end device may be generated by using a method in the prior art. For brevity, no description is provided herein.

It should be understood that the first PAM signal and a second PAM signal include a same quantity of levels. To be specific, according to the signal generation method in this embodiment of the present invention, if a PAM signal (denoted as a PAM signal #1 for ease of differentiation and description) with unequal-interval distribution needs to be generated, first, the signal transmit end device needs to generate a PAM signal (denoted as a PAM signal #2 for ease of differentiation and description) that includes a same quantity of level amplitudes, and sends the PAM signal #2 to the signal receive end device; then, the signal receive end device feeds back information of the PAM signal #2 to the signal transmit end device, so that the signal transmit end device adjusts (or optimizes) the PAM signal #2, and finally generates the PAM signal #1. A process in which the signal transmit end device adjusts the PAM signal #2 is a process of determining level amplitudes of the PAM signal #1. Therefore, specific magnitude of the level amplitudes of the finally generated PAM signal #1 is known. In other words, according to the signal generation method in this embodiment of the present invention, a PAM signal of which level amplitudes are distributed at unequal intervals and have known specific magnitude can be generated.

102. The signal receive end device determines feedback parameters based on the first PAM signal.

In this embodiment of the present invention, the signal receive end device determines the feedback parameters in two situations.

Situation 1

An average power P and an extinction ratio ER of N first levels corresponding to the N first level amplitudes included by the first PAM signal are determined.

It should be noted that the average power P is an average of powers of a plurality of levels included by the PAM signal. The extinction ratio (ER) is a ratio of a level power of a highest level to a level power of a lowest level in the N first levels included by the first PAM signal.

For example, if powers of four level included by a PAM4 signal are successively denoted as P₀, P₁, P₂, and P₃ in ascending order, P=(P₀+P₁+P₂+P₃)/4, and an ER may be represented as ER=P₃/P₀. For another example, if powers of eight level included by a PAM8 signal are successively denoted as P₀, P₁, P₂, . . . , and P₇ in ascending order, P=(P₀+P₁+ . . . +P₇)/8, and ER may be represented as ER=P₇/P₀.

The signal receive end device may detect the received first PAM signal, to obtain an average power and an ER of the first PAM signal.

Situation 2

A maximum level power and a minimum level power in powers of N first levels included by the first PAM signal are determined.

Specifically, the signal receive end device may determine a maximum power (namely, the maximum level power) and a minimum power (namely, the minimum level power) by using the prior art. For brevity, details are not described herein. For example, in a time period in which the signal receive end device receives the first PAM signal sent by the signal transmit end device, the signal receive end device may detect the first PAM signal by using a high-speed photodiode (PD), to obtain the maximum power and the minimum power through detection.

103. The signal transmit end device receives the feedback parameters sent by the signal receive end device.

Specifically, the signal transmit end device may receive, in a plurality of manners, the feedback parameters sent by the signal receive end device. For example, the signal receive end device may perform, based on a preset agreement in a system, feedback upon reception of the PAM signal. Alternatively, the signal receive end device may report the feedback parameters to the signal transmit end device after receiving a report request from the signal transmit end device. This embodiment of the present invention sets no special limitation thereto.

104. The signal transmit end device determines N target level amplitudes based on the feedback parameters.

It should be understood that the N target level amplitudes herein are N level amplitudes of a PAM signal that the signal transmit end device needs to finally generate, to be specific, N level amplitudes of the second PAM signal.

Optionally, in an embodiment, that the signal transmit end device determines N target level amplitudes based on the feedback parameters includes: the signal transmit end device generates N reference level amplitudes based on the feedback parameters and preset parameters; the signal transmit end device determines a quality factor between every two adjacent reference level amplitudes in the N reference level amplitudes, to obtain (N−1) quality factors; and when a difference between any two quality factors in the (N−1) quality factors is less than or equal to a preset threshold, the signal transmit end device determines the N reference level amplitudes as the N target level amplitudes.

The following describes a specific process of determining the target level amplitudes in this embodiment of the present invention in detail.

For ease of understanding, parameters in this embodiment of the present invention are first briefly described with reference to FIG. 2 by using a PAM4 signal as an example.

FIG. 2 is a schematic diagram of a multi-amplitude PAM signal according to an embodiment of the present invention. As shown in FIG. 2, a PAM4 signal includes four levels (or four level amplitudes), and powers of the four levels are successively P₀, P₁, P₂, and P₃ in ascending order. P is an average power of the four powers. An extinction ratio (ER) represents a ratio of a maximum power to a minimum power in the powers corresponding to the four levels included by the PAM4 signal.

In a transmission process of the multi-amplitude PAM signal, a crosstalk degree between every two adjacent levels may be measured by using a ratio (to be specific, an extinction ratio of sub-eyes in an eye pattern consisting of the PAM signal) of powers of the two adjacent levels. A larger “sub-eye” and a more regular eye pattern indicate smaller intersymbol crosstalk, and on the contrary, greater intersymbol crosstalk.

For example, an extinction ratio between P₁ and P₀ is er₁, and an extinction ratio between P₂ and P₁ is er₂.

It can be known based on the foregoing description of the parameters that the parameters meet the following relational expressions:

P=(P₀+P₁+P₂+P₃)/4 (1);

ER=P₃/P₀ (2);

er₁=P₁/P₀ (3);

er₂=P₂/P₁ (4);

er₃=P₃/P₂ (5); and

ER=er₁×er₂×er₃ (6).

It can be known based on a relationship among the foregoing parameters that a relationship between P and P₀ may be represented as: P₀=4×P/(1+er₁+ER/ER+er₃).

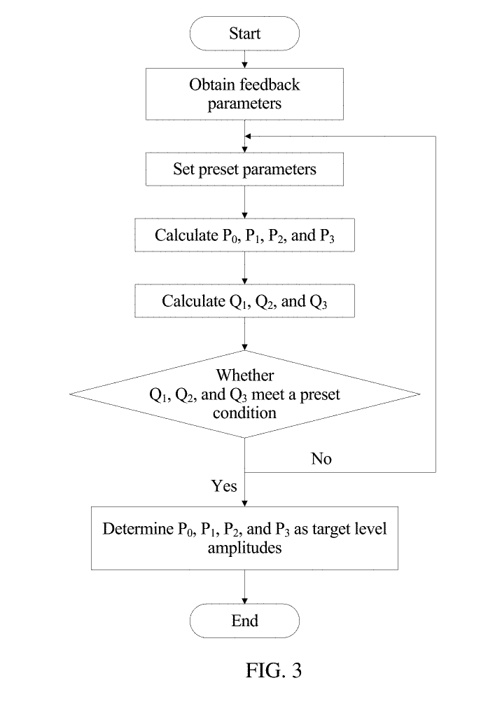

How to determine the target level amplitudes is described in detail below with reference to FIG. 3.

It should be understood that, in this embodiment of the present invention, the target level amplitudes are a plurality of level amplitudes included by an optimal PAM signal that meets a current network status and is determined by a system. In other words, if specific magnitude of level amplitudes included by a multi-amplitude PAM signal with unequal-interval distribution is determined, the multi-amplitude PAM signal with unequal-interval distribution is determined.

A process of determining the target level amplitudes is described in detail below with reference to FIG. 3.

FIG. 3 is a flowchart of determining target level amplitudes of a PAM4 signal with unequal-interval distribution. As shown in FIG. 3, a process in which a signal transmit end device determines target level amplitudes mainly includes the following steps.

(1) Obtain feedback parameters.

Specifically, the signal transmit end device may receive P and ER fed back by a signal receive end device. Alternatively, the signal transmit end device may receive P₃ and P₀ fed back by a signal receive end device.

(2) Set preset parameters.

If the signal receive end device reports P and ER to the signal transmit end device, the signal receive end device may set values of any two parameters of P₀, P₁, P₂, P₃, er₁, er₂, and er₃. In other words, initial values are set for any two of the seven parameters.

Specifically, in a process of setting the initial values, if initial values of er₁, er₂, and er₃ are to be set, the specified initial values need to be less than ER; and if initial values of P₀, P₁, P₂, and P₃ are to be set, specified magnitude of P₀ and P₁ needs to be less than P, and specified magnitude of P₂ and P₃ needs to be greater than P.

It should be understood that a magnitude relationship between the foregoing preset parameters may be used as a preferred manner. The signal generation method in this embodiment of the present invention is used for generating a PAM signal with unequal-interval distribution, and when level amplitudes increase, an interval between the level amplitudes also needs to increase, so that a Q value between adjacent levels is not reduced. Therefore, the level amplitudes are preferentially set to an average location, so that magnitude of the target level amplitudes can be determined more quickly.

If the signal receive end device feeds back a maximum power P₃ and a minimum power P₀, the signal receive end device may set values of any two parameters of er₁, er₂, and er₃.

For example, the signal transmit end device sets initial values of er₁ and er₃. It can be known based on the relational expressions (1) to (5) that, P₁=P₀×er₁ and P₂=P₃/er₃. Therefore, the signal transmit end device may obtain specific values of P₀, P₁, P₂, and P₃ through calculation.

It may be understood that, during implementation of the present invention, the signal transmit end device may specifically determine, based on the feedback parameters sent by the signal receive end device, which parameters are to be set as the preset parameters.

For example, when the feedback parameters are an average power and an extinction ratio ER, it can be known based on the foregoing relational expressions (1) to (5) that, an equation set consisting of the relational expressions (1) to (5) includes five equations and seven parameters, and the seven parameters are respectively P₀, P₁, P₂, P₃, er₁, er₂, and er₃ (because P and ER are known). If values of P₀, P₁, P₂, and P₃ need to be obtained through calculation, actually only two parameters need to be randomly selected from the foregoing seven parameters, initial values of the two parameters are set, and an equation set including five equations and five parameters is obtained. In this case, the equation set has a unique solution. Therefore, when the feedback parameters are the average power P and the extinction ratio ER, the preset parameters may be any two of the foregoing seven parameters of P₀, P₁, P₂, P₃, er₁, er₂, and er₃.

For another example, when the feedback parameters are the maximum power P₃ and the minimum power P₀, it can be known based on the foregoing relational expressions (1) to (5) that, P₁=P₀×er₁ and P₂=P₃/er₃. Because P₃ and P₀ are known, the specific values of P₀, P₁, P₂, and P₃ can be obtained through calculation only by setting er₁ and er₃ as the preset parameters and setting initial values of er₁ and er₃.

A process of calculating powers of levels of the PAM4 signal based on the feedback parameters and the preset parameters is described in detail above only by using PAM4 as an example. A process of calculating a PAM signal with other amplitudes such as PAM8 and PAM16 is similar. For brevity, details are not described herein again.

(3) Calculate reference level amplitudes based on the feedback parameters and the preset parameters.

After setting the initial values of the preset parameters, the signal transmit end device may obtain powers P₀, P₁, P₂, and P₃ corresponding to reference levels through calculation based on the foregoing relational expressions (1) to (5).

It should be noted that specific magnitude of level amplitudes may be determined by calculating powers of levels included by a PAM signal. If the powers of the levels of the PAM signal are determined, the level amplitudes of the PAM signal are determined, and the PAM signal is determined.

As described above, for calculation of the reference level amplitudes (or calculation of the powers of the reference levels), the signal receive end device may feed back the average power P and the extinction ratio ER of the first PAM signal to the signal transmit end device, or feed back the maximum power and the minimum power to the signal transmit end device. The signal transmit end device may obtain P₀, P₁, P₂, and P₃ through calculation based on the feedback parameters sent by the signal receive end device.

It should be understood that P₀, P₁, P₂, and P₃ herein may be corresponding to the reference level amplitudes in this embodiment of the present invention. The signal transmit end device may obtain the target level amplitudes by adjusting reference levels.

(4) Calculate quality factors Q₁, Q₂, and Q₃ between every two adjacent reference level amplitudes.

The signal transmit end device calculates a Q value between every two adjacent reference level amplitudes. PAM4 is used as an example. There are four reference level amplitudes, and a Q value between every two adjacent amplitudes is calculated, to obtain three Q values: Q₁, Q₂, and Q₃.

It may be understood that a quantity of Q values is corresponding to a quantity of level amplitudes included by the PAM signal. For example, PAM8 includes eight level amplitudes, and one Q value is obtained through calculation between every two adjacent level amplitudes. Therefore, seven Q values are obtained through calculation. Similarly, for PAM16, 15 Q values are obtained through calculation.

It should be noted that, during implementation of the present invention, two adjacent level amplitudes means being adjacent in terms of level amplitudes. For example, if amplitudes of four levels of the PAM4 signal are respectively A₁, A₂, A₃, and A₄, and 0<A₁<A₂<A₃<A₄, A1 and A₂ are adjacent level amplitudes, A₂ and A₃ are adjacent level amplitudes, and A₃ and A₄ are adjacent level amplitudes.

(5) Determine whether differences among Q₁, Q₂, and Q₃ are less than a preset threshold.

The signal transmit end device determines the plurality of Q values obtained through calculation, and determines whether a difference between every two Q values is less than or equal to the preset threshold (namely, a preset condition in FIG. 3).

It should be understood that, in this embodiment of the present invention, the preset threshold is a tiny reference value that is set by the signal transmit end device. When absolute values of the differences among Q₁, Q₂, and Q₃ are less than or equal to the reference value, a PAM signal output by the signal transmit end device in this case is an optimal signal of a current link.

(6) If the differences among Q₁, Q₂, and Q₃ are less than or equal to the preset threshold, determine P₀, P₁, P₂, and P₃ as the target level amplitudes.

When the absolute values of the differences among Q₁, Q₂, and Q₃ are less than or equal to the preset threshold, P₀, P₁, P₂, and P₃ are determined as the target level amplitudes. In other words, the signal transmit end device outputs a second PAM4 signal, and powers of four levels of the second PAM4 signal are respectively P₀, P₁, P₂, and P₃.

(7) If the differences among Q₁, Q₂, and Q₃ are greater than the preset threshold, reset preset parameters.

It should be understood that, if the differences among Q₁, Q₂, and Q₃ are greater than the preset threshold, it indicates that Q values of an eye pattern consisting of the reference level amplitudes P₀, P₁, P₂, and P₃ are not optimal. Therefore, initial values of preset parameters need to be reset, and a group of new reference level amplitudes need to be obtained through calculation based on the reset preset parameters. Steps (2) to (5) in the foregoing process are repeated, until a group of reference level amplitudes meeting the preset threshold are obtained. A calculation process after the preset parameters are reset is the same as the foregoing steps (2) to (5), and details are not described herein again.

It should be understood that parameters P and ER in the foregoing relational expressions (1) to (5) may be obtained as reported by a signal receive end device. Therefore, there are seven parameters in the relational expressions (1) to (5) in total: P₀, P₁, P₂, P₃, er₁, er₂, and er₃. In other words, there are seven parameters and five equations. To make an equation set consisting of the foregoing five equations have a unique solution, it only requires to make a quantity of equations be equal to a quantity of unknown parameters. Therefore, provided that initial values are set for any two of the seven parameters P₀, P₁, P₂, P₃, er₁, er₂, and er₃, and the foregoing relational expressions (1) to (5), P, and ER are used, the signal transmit end device can obtain specific values of the foregoing four powers P₀, P₁, P₂ and P₃.

After the specific values of P₀, P₁, P₂, and P₃ are obtained, a Q value between powers (for example, P₁ and P₀, P₂ and P₁, and P₃ and P₂) of every two adjacent levels may be calculated. When a difference between the Q values is less than or equal to the preset threshold, a second PAM signal with unequal-interval distribution is generated.

Specifically, the Q values need to be obtained through calculation based on working parameters of a receiver component: an avalanche photodiode-receiver optical subassembly (APD-ROSA).

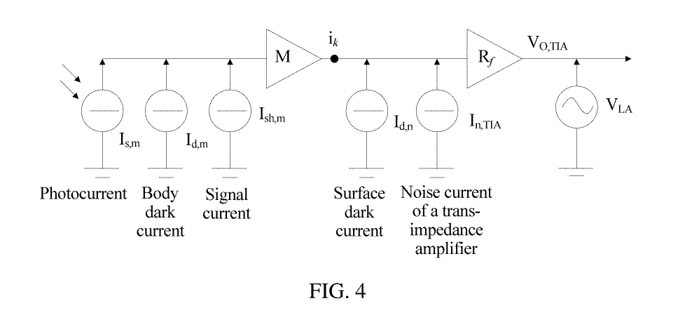

A working model of the APD-ROSA and how to obtain the Q value between every two adjacent levels through calculation based on the working parameters of the APD-ROSA are described in detail below with reference to FIG. 4.

FIG. 4 shows an APD-ROSA component model. As shown in FIG. 4, noise of an APD-ROSA (APD for short below) mainly comes from shot noise of the APD, body dark current noise of the APD, surface dark current noise of the APD, and thermal noise of a trans-impedance amplifier (TIA).

A noise current σₖ generated by the APD for optical signals of different signal strengths may be obtained through calculation based on the APD component model shown in FIG. 4 by using a relational expression (7):

$${σ}_{k} = \sqrt{\begin{matrix}2 q {M}^{2} \times F \times {BW}_{n} \times {i}_{sh , m} + 2 q \times {M}^{2} \times F \times \\ {BW}_{n} \times {i}_{d , m} + \overline{{i}_{d , n}^{2}} + \overline{{i}_{n , TIA}^{2}} + {( \frac{\overline{{V}_{LA}}}{{R}_{f}} )}^{2}\end{matrix}} . \qquad ( 7 )$$

Physical meanings of parameters in the relational expression (7) are as follows:

i_{sh,m}=M×Pₖ×R is a signal current generated after an optical signal with a signal power of Pₖ passes through the APD;

i_{d,m} is a body dark current of the APD;

i_{d,n} is a surface dark current of the APD, and i_{n, TIA} is noise of the TIA;

$${( \frac{\overline{{V}_{LA}}}{{R}_{f}} )}^{2}$$

is noise of a post amplifier inside the ROSA;

q is an electron charge constant, M is a multiplication factor of the APD, F is an excess noise factor of the APD, R is an intrinsic responsivity of the APD, BWₙ is bandwidth of the APD, n_{LA} is an equivalent input noise voltage of the post amplifier, and R_{f} is a reference resistance of the post amplifier.

Parameters such as M, F, R, BWₙ, n_{LA}, and R_{f} are intrinsic properties of the APD component, and may be obtained from a parameter list of the APD component.

The Q values between two adjacent levels may be obtained through calculation with reference to the relational expression (7) by using a relational expression (8):

$${Q}_{k} = \frac{{i}_{k} - {i}_{k - 1}}{{σ}_{k} + {σ}_{k - 1}} . \qquad ( 8 )$$

In the expression (8), iₖ represents a signal current of a k^{th} level of a multi-amplitude PAM signal, and σₖ represents a noise current of the k^{th} level.

It can be known based on the foregoing description that, after obtaining the power of each level of the PAM signal through calculation, the signal transmit end device may obtain a noise current of each level based on the relational expression (7), and obtain values of Q₁, Q₂, and Q₃ through calculation based on the relational expression (8).

105. The signal transmit end device generates a second PAM signal based on the N target level amplitudes.

Generating the second PAM signal based on the N target level amplitudes is using the N determined target level amplitudes as level amplitudes of the second PAM signal.

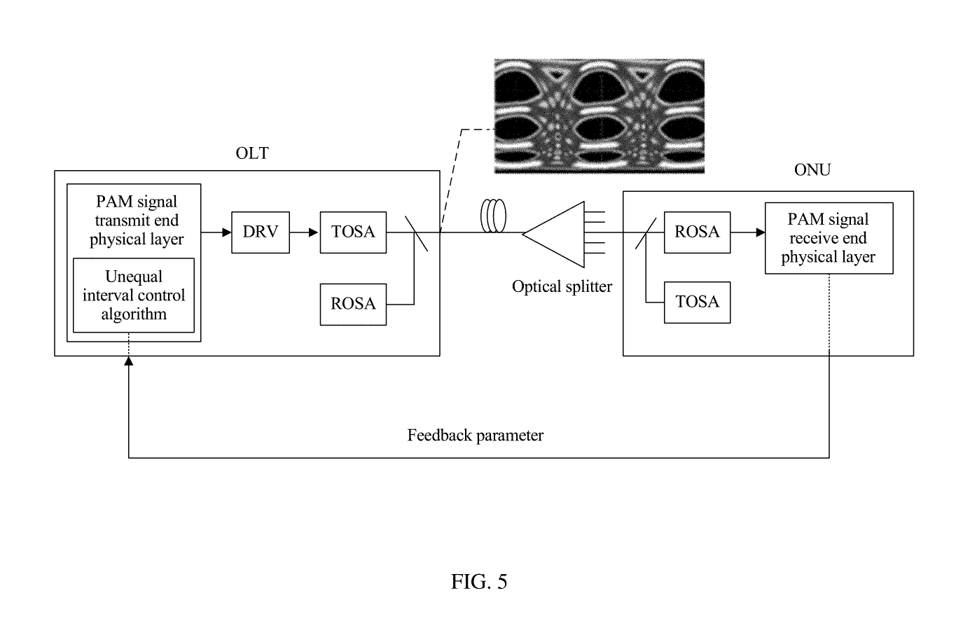

FIG. 5 is a schematic diagram of application of a signal generation method to a PON network according to an embodiment of the present invention. As shown in FIG. 5, an optical line terminal (OLT) includes a transmitter optical subassembly (TOSA), a receiver optical subassembly (ROSA), a driver (DRV), and a transmit end physical layer at which a PAM signal unequal interval control algorithm runs. The unequal interval control algorithm is used to adjust a PAM signal output by the OLT (or adjust an eye pattern consisting of the PAM signal), to generate a PAM signal with unequal-interval distribution. An optical network unit (ONU) includes a TOSA, a ROSA, and a PAM signal receive end physical layer. In the PON network, an ONU detects an average power P and an extinction ratio ER of a received PAM signal, and reports such information to the OLT. The OLT adjusts amplitudes of a multi-amplitude PAM signal by using the unequal interval control algorithm based on the information of P and ER reported by the ONU, to output an unequal-interval PAM signal. Because P and ER detected by the ONU are real information obtained after the PAM signal is transmitted in the network, the OLT may output an optimal PAM signal by optimizing the signal based on the information.

It should be noted that, the unequal interval control algorithm herein may be corresponding to a process of determining the target level amplitudes based on the feedback parameters and the preset parameters in this embodiment of the present invention.

Optionally, in an embodiment, before the signal transmit end device obtains the feedback parameters, the method further includes: the signal transmit end device sends a report request to the signal receive end device, where the report request is used to instruct the signal receive end device to report the feedback parameters.

In this embodiment of the present invention, the signal receive end device may send the feedback parameters to the signal transmit end device in a pre-agreed manner, or after receiving the report request of the signal transmit end device, the signal receive end device may send the feedback parameters to the signal transmit end device based on the report request.

In this embodiment of the present invention, the signal receive end device feeds back information (namely, the feedback parameters) of the received first PAM signal to the signal transmit end device, so that the signal transmit end device may obtain the second PAM signal through calculation based on the feedback parameters. In other words, specific magnitude of level amplitudes of the second PAM signal can be determined during generation of a PAM signal (namely, the second PAM signal) with unequal-interval distribution.

In this embodiment of the present invention, the PON network is specifically in two network forms: a broadcast-type network and a non-broadcast-type network.

The following describes application of the signal generation method in this embodiment of the present invention to the broadcast-type network and the non-broadcast-type network separately.

Broadcast-Type Network

For the broadcast-type network, an OLT (to be specific, an example of a signal transmit end device) sends a first PAM signal to all ONU (to be specific, an example of a signal receive end device) users in the network. Correspondingly, each ONU user in the network sends feedback parameters to the OLT. It is assumed that there are M ONU users in the network, and M≥2. The OLT receives M groups of feedback parameters. If the feedback parameters sent by the ONU user to the OLT are an average power P and an extinction ratio ER, the OLT needs to select, from the M groups of feedback parameters, a group of parameters with a minimum P value, and adjusts and optimizes the first PAM signal, to generate a second PAM signal.

It may be understood that, when an ONU (denoted as an ONU #1 for ease of description) corresponding to the group of parameters with the minimum average power P value can receive a PAM signal sent by the OLT, another ONU in the network can also receive the PAM signal sent by the OLT.

Non-Broadcast-Type Network

For the non-broadcast-type network, an OLT needs to send a particular PAM signal to a particular ONU. Different ONUs send PAM signals through time division multiplexing. In other words, the OLT sends only one PAM signal to a particular ONU in each time period.

It may be understood that, when the OLT sends a PAM signal to each ONU, the OLT needs to adjust and optimize the PAM signal based on feedback parameters of each ONU, and sends the adjusted and optimized PAM signal to the corresponding ONU.

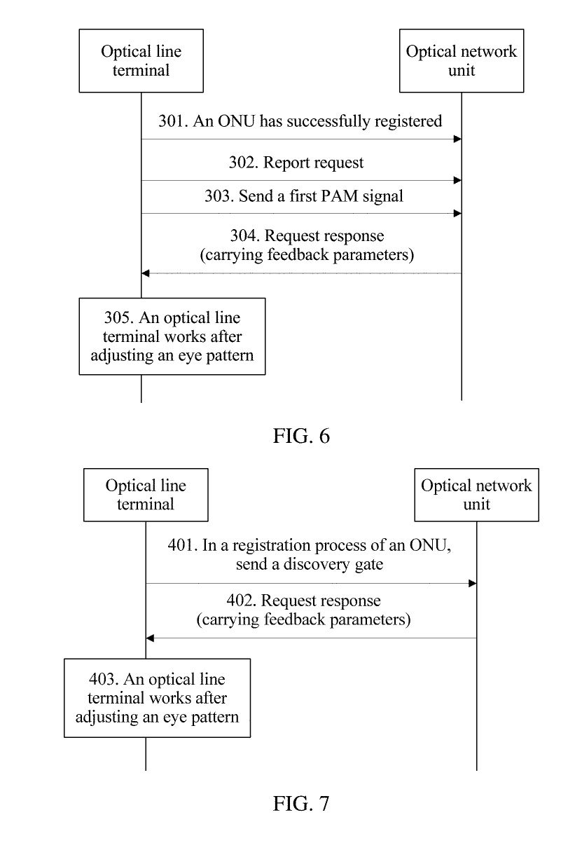

The following describes a process of information interaction between an OLT and an ONU with reference to FIG. 6 and FIG. 7.

FIG. 6 shows an example of a schematic interaction diagram of an OLT and an ONU. As shown in FIG. 6, a process of information interaction between the OLT and the ONU mainly includes step 301 to step 305.

301. An ONU has successfully registered.

It should be understood that, in a PON network, an ONU user first needs to register with the PON network before working.

302. An OLT sends a report request to the ONU.

In this embodiment of the present invention, the ONU needs to feed back information of a received PAM signal to the OLT. In a specific implementation process, the OLT may first add, to a downlink operation, administration and maintenance (OAM) message or a multi-point control protocol (MPCP) message, a command of requiring the ONU to report an average optical power and an extinction ratio received by the ONU (or report a maximum optical power value and a minimum optical power value). Information reported by the ONU includes at least three information fields: an ONU identifier, an extinction ratio ER, and an average optical power.

It should be understood that the ONU identifier is used to indicate an ONU, in the

PON network, that needs to report feedback parameters.

303. The OLT sends a PAM signal #1 to the ONU.

It should be understood that the PAM signal #1 herein is a multi-amplitude PAM signal that is sent to the ONU user before the OLT adjusts an eye pattern, so that the ONU user feeds back information (for example, an average power and an extinction ratio, or a maximum power value and a minimum power value) of the received PAM signal #1, to optimize parameters of the PAM signal #1.

It should be understood that there is no sequence for step 302 and step 303, and a sequence herein shall not constitute any limitation on the protection scope of the signal generation method in this embodiment of the present invention. For example, step 303 may be performed first, and then step 302 is performed.

304. The ONU sends a request response message to the OLT, where the request response message carries feedback parameters.

305. The OLT works after adjusting an eye pattern.

Specifically, the OLT adjusts (or optimizes) the parameters (for example, level amplitudes or an extinction ratio between adjacent level amplitudes) of the PAM signal #1 based on the feedback parameters reported by the ONU in step 304, determines a current working status, and outputs a PAM signal #2.

It should be understood that magnitude of adjusted level amplitudes is determined as magnitude of level amplitudes included by the PAM signal #2.

FIG. 7 shows another example of a schematic interaction diagram of an OLT and an ONU. As shown in FIG. 7, a process of information interaction between the OLT and the ONU mainly includes step 401 to step 403.

401. In a registration process of an ONU, an OLT sends a discovery gate to the ONU.

It can be known from the foregoing description that, the ONU first needs to register with a PON network before working. For ease of understanding and description, it is assumed that the ONU in the registration process is an ONU #1. Then, in a registration process of the ONU #1, the OLT sends a discovery gate to all ONUs in the network, to instruct another ONU other than the ONU #1 to stop reporting feedback parameters in a time period corresponding to the discovery gate, so that the time period corresponding to the discovery gate is used for reporting of the ONU #1 only.

402. The ONU sends a request response message to the OLT, where the request response message carries feedback parameters.

It should be understood that, after the ONU #1 performs successful registration, the ONU #1 may receive a multi-amplitude PAM signal sent by the OLT, and report information (for example, an average power and an extinction ratio, or a maximum power value and a minimum power value) of the received multi-amplitude PAM signal, so that the OLT adjusts and optimizes the multi-amplitude PAM signal based on the information reported by the ONU #1, and outputs the adjusted PAM signal.

403. The OLT works after adjusting an eye pattern.

It may be understood that, the OLT optimizes the PAM signal based on the information reported by the ONU #1, and outputs the optimized PAM signal.

According to the signal generation method in this embodiment of the present invention, a Q factor of the PAM signal can be improved, and a BER of a system can be reduced, thereby finally improving receiver sensitivity of the system and increasing a power budget of the system.

It should be understood that, in FIG. 6 and FIG. 7, the OLT is an example of a signal transmit end device, and the ONU is an example of a signal receive end device.

In this embodiment of the present invention, the signal receive end device feeds back information (namely, the feedback parameters) of the received first PAM signal to the signal transmit end device, so that the signal transmit end device may obtain the second PAM signal through calculation based on the feedback parameters. In other words, specific magnitude of level amplitudes of the second PAM signal can be determined during generation of a PAM signal (namely, the second PAM signal) with unequal-interval distribution.

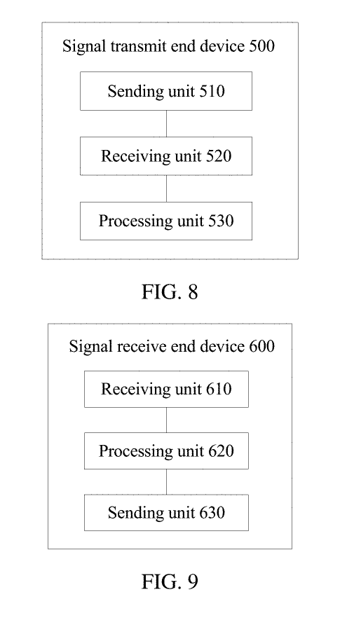

The foregoing describes the signal generation method according to the embodiments of the present invention in detail with reference to FIG. 1 to FIG. 7. The following describes a signal transmit end device and a signal receive end device according to embodiments of the present invention with reference to FIG. 8 and FIG. 9.

FIG. 8 is a schematic block diagram of a signal transmit end device 500 according to an embodiment of the present invention. As shown in FIG. 8, the signal transmit end device 500 includes: a sending unit 510, configured to send a first PAM signal to a signal receive end device, where the first PAM signal includes N first level amplitudes, and N≥3; a receiving unit 520, configured to receive feedback parameters sent by the signal receive end device, where the feedback parameters are determined by the signal receive end device based on the first PAM signal; and a processing unit 530, configured to determine N target level amplitudes based on the feedback parameters, where intervals between every two adjacent target level amplitudes in the N target level amplitudes are different from each other, where the processing unit 530 is further configured to generate, based on the N target level amplitudes, a second PAM signal that needs to be sent to the signal receive end device.

The units in the signal transmit end device 500 according to this embodiment of the present invention and the foregoing other operations or functions are separately for implementing a corresponding process executed by the signal transmit end device in the method 100. For brevity, details are not described herein again.

Therefore, in this embodiment of the present invention, the signal receive end device feeds back information (namely, the feedback parameters) of the received first PAM signal to the signal transmit end device, so that the signal transmit end device may obtain the second PAM signal through calculation based on the feedback parameters. In other words, specific magnitude of level amplitudes of the second PAM signal can be determined during generation of a PAM signal (namely, the second PAM signal) with unequal-interval distribution.

FIG. 9 is a schematic block diagram of a signal receive end device 600 according to an embodiment of the present invention. As shown in FIG. 9, the signal receive end device 600 includes: a receiving unit 610, configured to receive a first PAM signal sent by a signal transmit end device, where the first PAM signal includes N first level amplitudes, and N≥3; a processing unit 620, configured to determine feedback parameters based on the first PAM signal; and a sending unit 630, configured to send the feedback parameters to the signal transmit end device, so that the signal transmit end device determines N target level amplitudes based on the feedback parameters, and generates, based on the N target level amplitudes, a second PAM signal that needs to be sent to the signal receive end device, where intervals between every two adjacent target level amplitudes in the N target level amplitudes are different from each other.

The units in the signal receive end device 600 according to this embodiment of the present invention and the foregoing other operations or functions are separately for implementing a corresponding process executed by the signal receive end device in the method 100. For brevity, details are not described herein again.

Therefore, in this embodiment of the present invention, the signal receive end device feeds back information (namely, the feedback parameters) of the received first PAM signal to the signal transmit end device, so that the signal transmit end device may obtain the second PAM signal through calculation based on the feedback parameters. In other words, specific magnitude of level amplitudes of the second PAM signal can be determined during generation of a PAM signal (namely, the second PAM signal) with unequal-interval distribution.

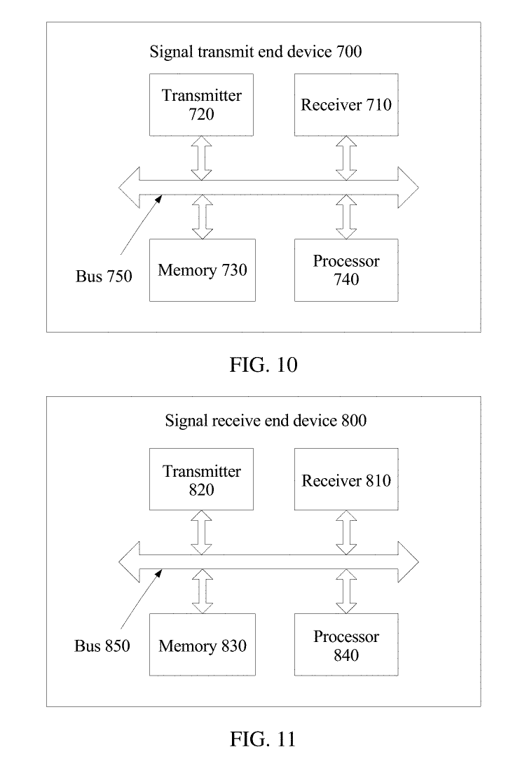

The foregoing describes the signal generation method according to the embodiments of the present invention in detail with reference to FIG. 1 to FIG. 7. The following describes a signal transmit end device and a signal receive end device according to embodiments of the present invention with reference to FIG. 10 and FIG. 11.

FIG. 10 is a schematic structural diagram of a signal transmit end device 700 according to an embodiment of the present invention. As shown in FIG. 10, the signal transmit end device 700 includes a receiver 710, a transmitter 720, a processor 740, a memory 730, and a bus system 750. The receiver 710, the transmitter 720, the processor 740, and the memory 730 are connected by using the bus system 750. The memory 730 is configured to store an instruction. The processor 740 is configured to execute the instruction stored in the memory 730, to control the receiver 710 to receive a signal and control the transmitter 720 to send a signal.

The transmitter 720 is configured to send a first PAM signal to a signal receive end device, where the first PAM signal includes N first level amplitudes, and N≥3.

The receiver 710 is configured to receive feedback parameters sent by the signal receive end device, where the feedback parameters are determined by the signal receive end device based on the first PAM signal.

The processor 740 is configured to determine N target level amplitudes based on the feedback parameters, where intervals between every two adjacent target level amplitudes in the N target level amplitudes are different from each other.

The processor 740 is further configured to generate, based on the N target level amplitudes, a second PAM signal that needs to be sent to the signal receive end device.

It should be understood that, in this embodiment of the present invention, the processor 740 may be a central processing unit (CPU), or the processor 740 may be another general purpose processor, a digital signal processor (DSP), an application-specific integrated circuit (ASIC), a field programmable gate array (FPGA) or another programmable logic device, a discrete gate or a transistor logic device, a discrete hardware component, or the like. The general purpose processor may be a microprocessor, or the processor may be any conventional processor or the like.

The memory 730 may include a read-only memory and a random access memory, and provide an instruction and data for the processor 740. A part of the memory 730 may further include a non-volatile random access memory. For example, the memory 730 may further store information of a device type.

The bus system 750 includes a power bus, a control bus, a status signal bus, and the like in addition to a data bus. However, for clarity of description, various buses are marked as the bus system 750 in the figure.

In an implementation process, steps of the foregoing method may be performed by an integrated logic circuit of hardware in the processor 740 or by an instruction in a software form. The steps of the signal generation method disclosed with reference to the embodiments of the present invention may be directly performed and completed by using a hardware processor, or may be performed and completed by using a combination of hardware in the processor and a software module. The software module may be located in a storage medium that is mature in the art, such as a random access memory, a flash memory, a read-only memory, a programmable read-only memory, an electrically erasable programmable memory, or a register. The storage medium is located in the memory 730, and the processor 740 reads information in the memory 730, and performs the steps of the foregoing method in combination with the hardware of the processor 740. To avoid repetition, details are not described herein again.

The units in the signal transmit end device 700 according to this embodiment of the present invention and the foregoing other operations or functions are separately for executing a corresponding process executed by the signal transmit end device in the method 100. For brevity, details are not described herein again.

Therefore, in this embodiment of the present invention, the signal receive end device feeds back information (namely, the feedback parameters) of the received first PAM signal to the signal transmit end device, so that the signal transmit end device may obtain the second PAM signal through calculation based on the feedback parameters. In other words, specific magnitude of level amplitudes of the second PAM signal can be determined during generation of a PAM signal (namely, the second PAM signal) with unequal-interval distribution.

FIG. 11 is a schematic structural diagram of a signal receive end device 800 according to an embodiment of the present invention. As shown in FIG. 11, the signal receive end device 800 includes a receiver 810, a transmitter 820, a processor 840, a memory 830, and a bus system 850. The receiver 810, the transmitter 820, the processor 840, and the memory 830 are connected by using the bus system 850. The memory 830 is configured to store an instruction. The processor 840 is configured to execute the instruction stored in the memory 830, to control the receiver 810 to receive a signal and control the transmitter 820 to send a signal.

The receiver 810 is configured to receive a first PAM signal sent by a signal transmit end device, where the first PAM signal includes N first level amplitudes, and N≥3.

The processor 830 is configured to determine feedback parameters based on the first PAM signal.

The transmitter 820 is configured to send the feedback parameters to the signal transmit end device, so that the signal transmit end device determines N target level amplitudes based on the feedback parameters, and generates, based on the N target level amplitudes, a second PAM signal that needs to be sent to the signal receive end device, where intervals between every two adjacent target level amplitudes in the N target level amplitudes are different from each other.

It should be understood that, in this embodiment of the present invention, the processor 840 may be a CPU, or the processor 840 may be another general purpose processor, a DSP, an ASIC, a FPGA or another programmable logic device, a discrete gate or a transistor logic device, a discrete hardware component, or the like. The general purpose processor may be a microprocessor, or the processor may be any conventional processor or the like.

The memory 830 may include a read-only memory and a random access memory, and provide an instruction and data for the processor 840. A part of the memory 830 may further include a non-volatile random access memory. For example, the memory 830 may further store information of a device type.

The bus system 850 includes a power bus, a control bus, a status signal bus, and the like in addition to a data bus. However, for clarity of description, various buses are marked as the bus system 850 in the figure.

In an implementation process, steps of the foregoing method may be performed by an integrated logic circuit of hardware in the processor 840 or by an instruction in a software form. The steps of the signal generation method disclosed with reference to the embodiments of the present invention may be directly performed and completed by using a hardware processor, or may be performed and completed by using a combination of hardware in the processor and a software module. The software module may be located in a storage medium that is mature in the art, such as a random access memory, a flash memory, a read-only memory, a programmable read-only memory, an electrically erasable programmable memory, or a register. The storage medium is located in the memory 830, and the processor 840 reads information in the memory 830, and performs the steps of the foregoing method in combination with the hardware of the processor 840. To avoid repetition, details are not described herein again.

The units in the signal receive end device 800 according to this embodiment of the present invention and the foregoing other operations or functions are separately for executing a corresponding process executed by the signal receive end device in the method 100. For brevity, details are not described herein again.

Therefore, in this embodiment of the present invention, the signal receive end device feeds back information (namely, the feedback parameters) of the received first PAM signal to the signal transmit end device, so that the signal transmit end device may obtain the second PAM signal through calculation based on the feedback parameters. In other words, specific magnitude of level amplitudes of the second PAM signal can be determined during generation of a PAM signal (namely, the second PAM signal) with unequal-interval distribution.

It should be understood that sequence numbers of the foregoing processes do not mean execution sequences in various embodiments of the present invention. The execution sequences of the processes should be determined according to functions and internal logic of the processes, and should not be construed as any limitation on the implementation processes of the embodiments of the present invention.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of the present invention may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present invention essentially, or the part contributing to the prior art, or some of the technical solutions may be implemented in a form of a software product. The computer software product is stored in a storage medium, and includes several instructions for instructing a computer device (which may be a personal computer, a server, or a network device) to perform all or some of the steps of the method described in the embodiments of the present invention. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A signal generation method, wherein the method comprises:
sending, by a signal transmit end device, a first pulse amplitude modulation (PAM) signal to a signal receive end device, wherein the first PAM signal comprises N first level amplitudes, and N≥3;
receiving, by the signal transmit end device, feedback parameters sent by the signal receive end device, wherein the feedback parameters are determined by the signal receive end device based on the first PAM signal;
determining, by the signal transmit end device, N target level amplitudes based on the feedback parameters, wherein intervals between every two adjacent target level amplitudes in the N target level amplitudes are different from each other; and
generating, by the signal transmit end device based on the N target level amplitudes, a second PAM signal that needs to be sent to the signal receive end device.

2. The method according to claim 1, wherein the determining, by the signal transmit end device, N target level amplitudes based on the feedback parameters comprises:
generating, by the signal transmit end device, N reference level amplitudes based on the feedback parameters and preset parameters;
determining, by the signal transmit end device, a quality factor between every two adjacent reference level amplitudes in the N reference level amplitudes, to obtain (N−1) quality factors; and
when a difference between any two quality factors in the (N−1) quality factors is less than or equal to a preset threshold, determining, by the signal transmit end device, the N reference level amplitudes as the N target level amplitudes.

3. The method according to claim 1, wherein before the receiving, by the signal transmit end device, feedback parameters sent by the signal receive end device, the method further comprises:
sending, by the signal transmit end device, a report request to the signal receive end device, wherein the report request is used to instruct the signal receive end device to report the feedback parameters.

4. The method according to 1, wherein the method is applied to a broadcast-type network, and the broadcast-type network comprises at least two signal receive end devices,
the sending, by a signal transmit end device, a first PAM signal to a signal receive end device comprises:
sending, by the signal transmit end device, the first PAM signal to the at least two signal receive end devices;
the receiving, by the signal transmit end device, feedback parameters sent by the signal receive end device comprises:
receiving, by the signal transmit end device, at least two feedback parameters sent by the at least two signal receive end devices, wherein the at least two feedback parameters correspond one-to-one to the at least two signal receive end devices; and
the determining, by the signal transmit end device, N target level amplitudes based on the feedback parameters comprises:
determining, by the signal transmit end device, the N target level amplitudes based on a minimum value of the at least two feedback parameters.

5. The method according to claim 2, wherein the feedback parameters are an average level power and an extinction ratio ER of N first levels, or the feedback parameters are a maximum level power and a minimum level power of N first levels, wherein
the N first levels correspond one-to-one to the N first level amplitudes, and each first level amplitude is an amplitude value of a corresponding first level.

6. The method according to claim 5, wherein a value of N is 4, and when the feedback parameters are the average level power and the extinction ratio ER, the preset parameters are any two of the four first levels and extinction ratios between every two adjacent levels in the four first levels; or
when the feedback parameters are the maximum level power and the minimum level power, the preset parameters are any two of extinction ratios between every two adjacent levels in the four first levels.

7. A signal generation method, wherein the method comprises:
receiving, by a signal receive end device, a first PAM signal sent by a signal transmit end device, wherein the first PAM signal comprises N first level amplitudes, and N3;
determining, by the signal receive end device, feedback parameters based on the first PAM signal; and
sending, by the signal receive end device, the feedback parameters to the signal transmit end device, so that the signal transmit end device determines N target level amplitudes based on the feedback parameters, and generates, based on the N target level amplitudes, a second PAM signal that needs to be sent to the signal receive end device, wherein intervals between every two adjacent target level amplitudes in the N target level amplitudes are different from each other.

8. The method according to claim 7, wherein before the sending, by the signal receive end device, the feedback parameters to the signal transmit end device, the method further comprises:
receiving, by the signal receive end device, a report request sent by the signal transmit end device, wherein the report request is used to instruct the signal receive end device to report the feedback parameters; and
the sending, by the signal receive end device, the feedback parameters to the signal transmit end device comprises:
sending, by the signal receive end device, the feedback parameters to the signal transmit end device based on the report request.

9. The method according to claim 7, wherein the feedback parameters are an average level power and an extinction ratio ER of N first levels, or the feedback parameters are a maximum level power and a minimum level power of N first levels, wherein
the N first levels correspond one-to-one to the N first level amplitudes, and each first level amplitude is an amplitude value of a corresponding first level.

10. A signal transmit end device, wherein the device comprises:
a transmitter, configured to send a first PAM signal to a signal receive end device, wherein the first PAM signal comprises N first level amplitudes, and N≥3;
a receiver, configured to receive feedback parameters sent by the signal receive end device, wherein the feedback parameters are determined by the signal receive end device based on the first PAM signal; and
a processor, configured to determine N target level amplitudes based on the feedback parameters, wherein intervals between every two adjacent target level amplitudes in the N target level amplitudes are different from each other, wherein
the processing unit is further configured to generate, based on the N target level amplitudes, a second PAM signal that needs to be sent to the signal receive end device.

11. The signal transmit end device according to claim 10, wherein the processor is specifically configured to:
generate N reference level amplitudes based on the feedback parameters and preset parameters;
determine a quality factor between every two adjacent reference level amplitudes in the N reference level amplitudes, to obtain (N−1) quality factors; and
when a difference between any two quality factors in the (N−1) quality factors is less than or equal to a preset threshold, determine the N reference level amplitudes as the N target level amplitudes.

12. The signal transmit end device according to claim 10, wherein the receiver is specifically configured to send a report request to the signal receive end device, wherein the report request is used to instruct the signal receive end device to report the feedback parameters.

13. The signal transmit end device according to claim 11, wherein the receiver is specifically configured to send a report request to the signal receive end device, wherein the report request is used to instruct the signal receive end device to report the feedback parameters.

14. The signal transmit end device according to claim 10, wherein the signal transmit end device and the signal receive end device are configured in a broadcast-type network, and the broadcast-type network comprises at least two signal receive end devices, and
the transmitter is specifically configured to send the first PAM signal to the at least two signal receive end devices;
the receiver is specifically configured to receive at least two feedback parameters sent by the at least two signal receive end devices, wherein the at least two feedback parameters correspond one-to-one to the at least two signal receive end devices; and
the processing unit is specifically configured to determine the N target level amplitudes based on a minimum value of the at least two feedback parameters.

15. The signal transmit end device according to claim 10, wherein the feedback parameters are an average level power and an extinction ratio ER of N first levels, or the feedback parameters are a maximum level power and a minimum level power of N first levels, wherein
the N first levels correspond one-to-one to the N first level amplitudes, and each first level amplitude is an amplitude value of a corresponding first level.

16. The signal transmit end device according to claim 15, wherein a value of N is 4, and when the feedback parameters are the average level power and the extinction ratio ER, the preset parameters are any two of extinction ratios between every two adjacent levels in the four first levels; or
when the feedback parameters are the maximum level power and the minimum level power, the preset parameters are any two of extinction ratios between every two adjacent levels in the four first levels.

17. A signal receive end device, wherein the signal receive end device comprises:
a receiver, configured to receive a first PAM signal sent by a signal transmit end device, wherein the first PAM signal comprises N first level amplitudes, and N≥3;
a processor, configured to determine feedback parameters based on the first PAM signal; and
a transmitter, configured to send the feedback parameters to the signal transmit end device, so that the signal transmit end device determines N target level amplitudes based on the feedback parameters, and generates, based on the N target level amplitudes, a second PAM signal that needs to be sent to the signal receive end device, wherein intervals between every two adjacent target level amplitudes in the N target level amplitudes are different from each other.

18. The signal receive end device according to claim 17, wherein before the transmitter sends the feedback parameters to the signal transmit end device, the receiver is specifically configured to receive a report request sent by the signal transmit end device, wherein the report request is used to instruct the signal receive end device to report the feedback parameters; and
the transmitter is specifically configured to send the feedback parameters to the signal transmit end device based on the report request.

19. The signal receive end device according to claim 17, wherein the feedback parameters are an average level power and an extinction ratio ER of N first levels, or the feedback parameters are a maximum level power and a minimum level power of N first levels, wherein
the N first levels correspond one-to-one to the N first level amplitudes, and each first level amplitude is an amplitude value of a corresponding first level.

20. The signal receive end device according to claim 18, wherein the feedback parameters are an average level power and an extinction ratio ER of N first levels, or the feedback parameters are a maximum level power and a minimum level power of N first levels, wherein
the N first levels correspond one-to-one to the N first level amplitudes, and each first level amplitude is an amplitude value of a corresponding first level.
